(19) United States
(12) Patent Application Publication
(10) Pub. No.: US 2003/0026552 A1
(43) Pub. Date: Feb. 6, 2003

(54) Package apparatus

(76) Inventor: Alan Goode, Felixstowe (GB)

Correspondence Address: Paul D. Greeley, Esq., Ohlandt, Greeley, Ruggieo & Perle, L.L.P., One Landmark Square, 10th Floor, Stamford, CT, 06901-2682, US

(21) Appl. No.: 09/921,089

(22) Filed: Aug. 2, 2001

(51) Int. Cl. G02B 6/42

(52) U.S. Cl. 385/88

(57) ABSTRACT

Existing packages for photodiodes employ a silicone sealant to prevent moisture ingress and an adhesive to encapsulate the silicone covered photodiode. Differing coefficients of thermal expansion of the silicone and the adhesive can result in the disadvantageous formation of vacuum voids. The present invention overcomes this disadvantage by providing a package in which a silicon micro-bench supports a photodiode, the photodiode being substantially covered with silicone and not further encapsulated with an adhesive.

### FIELD OF THE INVENTION

The present invention relates to a package apparatus of the type used to house an optoelectronic device, such as a photodiode.

### BACKGROUND OF THE INVENTION

An optical transceiver module is package comprising a transmission connector for coupling a first optical fibre to an optical transmitter sub-assembly, a reception connector for coupling a second optical fibre to an optical receiver sub-assembly, a transmitter Printed Circuit Board (PCB) coupled to the optical transmitter sub-assembly, and a receiver PCB coupled to the optical receiver sub-assembly. The optical transceiver module is typically manufactured by an optoelectronic equipment manufacturer for a customer, the customer being desirous to couple the optical transceiver module to a custom-built PCB.

Due to the different physical configurations of different optical transceiver designs of various optoelectronic equipment manufacturers, a number of these optoelectronic equipment manufacturers agreed to conform to certain common configuration parameters (known as the small form factor multisource agreement for optical transceivers). In particular, spacings between pins of the transceiver module relating to the optical receiver sub-assembly and a receiver optical reference plane of the optical receiver sub-assembly, and between pins of the transceiver module relating to the optical transmitter sub-assembly and a transmitter optical reference plane of the optical transmitter sub-assembly have been agreed. Consequently, the customer is free to design the custom PCB without the restriction of having to source optical transceiver equipment from a single optoelectronic equipment manufacturer.

The agreed common configuration parameters relating to the optical transceiver module are such that the above mentioned spacings are 1.33 mm each. Such distances are very small and are very difficult to attain the spacings between the pins and the respective optical reference planes with direct connections between the receiver PCB and the optical receiver sub-assembly and the transmitter PCB and the transmitter sub-assembly.

In order to remove the fixed relationship between the pins of the receiver PCB and the optical receiver sub-assembly and the pins of the transmitter PCB and the optical transmitter sub-assembly, it is known to couple one end of a first flex circuit to the receiver PCB and the other end of the first flex circuit to the optical receiver sub-assembly. Similarly, one end of a second flex circuit is coupled to the transmitter PCB and the other end of the second flex circuit is coupled to the optical transmitter sub-assembly. The use of the first and second flex circuits make configurations of the transmitter PCB, the receiver PCB, the optical transmitter sub-assembly and optical receiver sub-assembly within the optical transceiver module more versatile with respect to other known optical transceiver module designs requiring direct connection between the receiver PCB and the optical receiver sub-assembly and between the transmitter PCB and the optical transmitter sub-assembly.

However, each of the first and second flex circuits require twice as many solder connections than a direct connection. Also, the first and second flex circuits constitute additional components. The above disadvantages impact upon yield, cost and reliability of the optical transceiver module.

In relation to the optical receiver sub-assembly, packaged photodiodes have previously been used as optical receiver sub-assemblies, but the design of some of the packages for the photodiodes have resulted in the previously mentioned need for flex circuits. In this respect, an example of a known optical receiver sub-assembly comprises a package providing protective space and in which a photodiode is mounted. The shape of the housing results in less flexibility when designing optical transceiver modules that conform to the above Small Form Factor (SFF) requirements, especially, but not exclusively, the spacing between the pins of the optical transceiver module associated with the optical receiver sub-assembly and the optical reference plane of the optical receiver sub-assembly.

As an alternative, it is known to provide a silicon micro-bench upon which a photodiode is mounted. The micro-bench with the photodiode is mounted directly onto the receiver PCB. A globule of silicone is deposited over the photodiode and a region of an optical fibre coupled to the photodiode. A globule of an adhesive, such as Hysol EO 1062, is then deposited over the silicone to encapsulate the silicone, and hence the photodiode and some of the optical fibre. The silicone covering the photodiode and a region of the optical fibre serves to prevent moisture ingress. However, vacuum voids can sometimes form between the globule of silicone and the globule of the adhesive as a result of the silicone having a different coefficient of expansion from the globule material. The vacuum voids introduce a change in refractive index, resulting in a degradation in sensitivity of the optical receiver sub-assembly.

In relation to the Synchronous Optical NETwork (SONET) technical specification for OC48 products, a performance consideration for optical receiver sub-assemblies is Optical Return Loss (ORL) which should be below 27 dB. Known optical receiver sub-assemblies require an expensive, nonstandard, angled optical pachcords to achieve this ORL.

### SUMMARY OF THE INVENTION

According to the present invention, there is provided a package apparatus for an optoelectronic device, the package comprising: a receptacle containing a support device supporting an optoelectronic device; a plurality of leads communicating between an interior of the receptacle and an exterior of the receptacle, wherein the support device and the optoelectronic device are substantially covered in a sealant material.

Preferably, a second type of material, for example an adhesive, does not encapsulate the optoelectronic device and/or the sealant material. The adhesive may be deposited adjacent the substantially silicone covered optoelectronic device to secure an optical fibre to the support device.

Preferably, the receptacle comprises a recess, the support device being disposed within the recess.

Preferably, the receptacle comprises a side wall having an opening for permitting passage of an optical fibre into the receptacle.

Preferably, the apparatus further comprises a ferrule disposed, in part, in the aperture.

Preferably, the side wall has an outer surface relative to the open chamber, the aperture being disposed non-centrally in the outer surface.

Preferably, the outer ferrule is a ceramic ferrule.

Preferably, the side wall comprises an outer surface and a shoulder formed with the outer surface, the shoulder surrounding the aperture. More preferably, the shoulder is defined by a protrusion that extends away from the outer surface of the side wall.

Preferably, a ferrule is disposed, in part, within the aperture, an annular volume being defined between the shoulder and the ferrule. More preferably, an electrically insulating washer is disposed in the annular volume.

Preferably, an electrically insulating element is disposed adjacent the shoulder.

Preferably, the cross sectional area of the receptacle is substantially rectangular.

It is thus also possible to provide a package apparatus that is shaped and/or configured so as to facilitate conformity with the small form factor requirement. In addition, the package apparatus facilitates compliance with the SONET OC48 specification without the need for expensive angled patchcords. Also, the formation of vacuum voids is not a consideration due to the absence of the globular material. Advantageously, the use of the ceramic ferrule results in the optical receiver sub-assembly exhibiting a good ORL, whilst the cost of the ferrule is lower than other high-precision ferrules. Also, the provision of the insulating element serves to electrically isolate the receptacle from a receiver nose that can subsequently be attached to the receptacle.

### BRIEF DESCRIPTION OF THE DRAWINGS

At least one embodiment of the invention will now be described, by way of example only, with reference to the accompanying drawings, in which:

FIG. 1 is a schematic diagram of a perspective view of an optoelectronic transceiver module;

FIG. 2 is a cross-section view, along line A-A, of the module of FIG. 1; and

FIG. 3 is a plan view of the module of FIG. 1;

FIG. 4 is a plan view of an optical receiver sub-assembly constituting an embodiment of the present invention; and

FIG. 5 is a perspective view of the sub-assembly of FIG. 4.

### DETAILED DESCRIPTION OF AT LEAST ONE PREFERRED EMBODIMENT

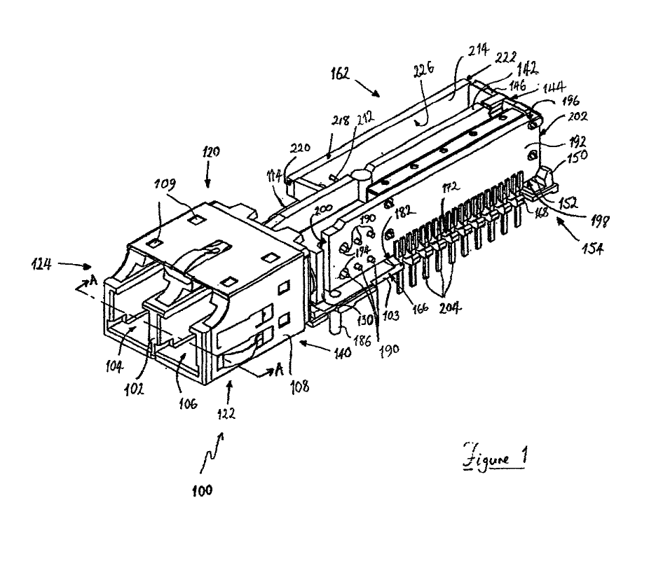

Referring to FIG. 1, an optical transceiver module comprises a skeleton structure 100 and an outer protective housing (not shown). The skeleton structure 100 comprises a socket portion 102 and a platform portion 103. The socket portion 102 comprises a transmission socket 104 and a reception socket 106, each shaped to receive a complementarily formed transmission plug (not shown) and a complementarily formed reception plug (not shown), respectively. The transmission plug can be coupled to an outgoing optical fibre (not shown) used to carry optical signals transmitted from the optical transceiver module. Similarly, the reception plug can be coupled to an incoming optical fibre (not shown) used to carry optical signals for receipt by the optical transceiver module.

A sleeve-like ground cap 108 surrounds the socket portion 102 and comprises engagement tabs 109 depending towards the socket portion for engagement with complementary depressions (not shown) formed on an outer surface (not shown) of the socket portion 102. The ground cap 108 is shaped to be received by a front panel aperture (not shown) of a customer's apparatus that uses the optical transceiver module. The front panel aperture is typically maintained at ground potential and so, by virtue with the ground cap's connection with other parts, maintains the ground cap 108, the interior of the transmission socket 104, the interior of the reception socket 106 and the transmitter and receiver subassemblies 114, 130 at ground potential.

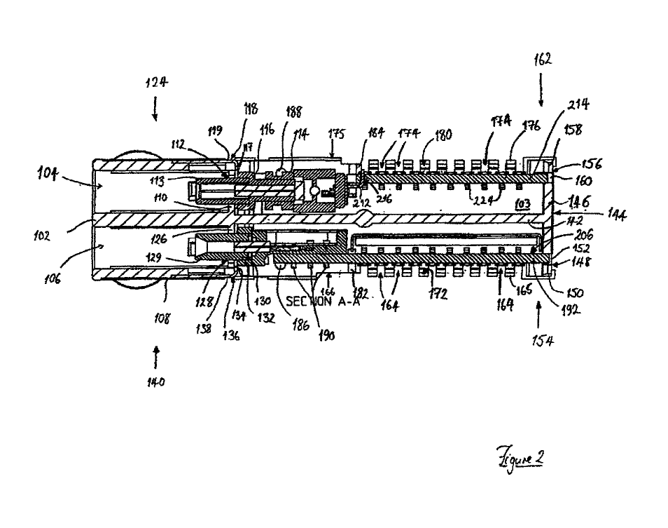

The transmission socket 104 has a first rear wall 110 (FIG. 2) comprising a first circular aperture 112 through which a coupling portion 113 of a transmitter optical sub-assembly 114 passes so that the transmitter sub-assembly 114 is located, in-part, within the transmission socket 104. The transmitter sub-assembly 114 also passes through a circular aperture in a first tab 117 of a first flexible coupling plate 118. A circumferential shoulder 116 of the transmitter sub-assembly 114 abuts, and is welded to, the first tab 117. The first tab 117 is joined to a second tab (not shown) and a third tab (not shown) by a first central rectangular portion 119. The first central portion 119 lies against a first side surface 124 of the socket portion 102. The first tab 117 of the first coupling plate 118 wraps around the first rear wall 110 and lies against the first rear wall 110 so that the circular aperture in the first tab 117 is aligned with the first circular aperture 112. The second and third tabs each comprise respective engagement tabs (not shown), the second and third tabs each wrapping around the socket portion 102 so that the second tab lies against, and the respective engagement tab co-operates with, an upper surface 120 (FIG. 1) of the socket portion 102, and the third tab lies against, and the respective engagement tab co-operates with, a lower surface 122 of the socket portion 102.

The reception socket 106 has a second rear wall 126 (FIG. 2) comprising a second circular aperture 128 through which a coupling portion 129 of a receiver optical sub-assembly 130 passes so that the receiver sub-assembly is located, in-part, within the reception socket 106. The reception sub-assembly 130 also passes through a circular aperture in a first tab 134 of a second flexible coupling plate 136. A circumferential shoulder 132 of the receiver optical sub-assembly 130 abuts, and is welded to, the first tab 134. The first tab 134 is joined to a second tab (not shown) and a third tab (not shown) by a second central rectangular portion 138. The second central portion 138 lies against a second side surface 140 of the socket portion 102. The first tab 134 of the second coupling plate 136 wraps around the second rear wall 126 and lies against the second rear wall 126 so that the circular aperture in the first tab 134 is aligned with the second circular aperture 128. The second and third tabs of the second flexible coupling plate 136 each comprise respective engagement tabs (not shown), the second and third tabs each wrapping around the socket portion 102, so that the second tab lies against, and the respective engagement tab cooperates with, the upper surface 120 (FIG. 1) of the socket portion 102, and the third tab lies against, and the respective engagement tab co-operates with, the lower surface 122 of the socket portion 102.

Referring to FIG. 1, the platform portion 103 is integrally formed with the socket portion 102 and comprises a vertical partition 142 extending from, and integrally formed with, the socket portion 102 to a transverse back plate 144 located at a distal end 144 of the platform portion 103 with respect to the socket portion 102. The vertical partition 142 is also integrally formed with the transverse back plate 146, the transverse back plate 146 being integrally formed with the platform portion 103. The vertical partition 142 provides the skeleton structure 100 with rigidity and strength.

At the distal end 144 of the platform portion 103, a first circuit board location slot 148 (FIG. 2) is defined by the transverse back plate 146, a first lug 150 extending away from the plane of the platform portion 103, and a first raised central portion 152 bridging the transverse back plate 146 and the first lug 150; the first raised control portion 152 is lower than the transverse back plate 146 and the first lug 150. The first circuit board location slot 148 is located on a first side 154 of the platform portion 103 and is integrally formed with the platform portion 103. Similarly, a second circuit board location slot 156 is located at the distal end 144 and defined by the transverse back plate 146, a second lug 158 extending away from the plane of the platform portion 103, and second raised central portion 160 bridging the transverse back plate 146 and the second lug 158; the second raised portion 160 is lower than the transverse back plate 146 and the second lug 158. The second circuit board location slot 156 is located on a second side 162 of the platform portion 103 and is integrally formed with the platform portion 103.

With reference to the first side 154 of the platform portion 103, a first array of recesses 164 is disposed in a first side edge 166 of the platform portion 103 adjacent the first circuit board location slot 148. The recesses of the first array of recesses 164 are separated by a plurality of first fingers 168 (FIG. 1). The plurality of first fingers 168 are each formed so as to be tine-like having an upper surface 172 that slopes away from the plane of the platform portion 103, i.e. the plurality of first fingers 168 thicken vertically.

Turning to the second side 162 of the platform portion 103, a second array of recesses 174 (FIG. 2) is disposed in a second side edge 175 of the platform portion 103 adjacent the second circuit board location slot 156. The recesses of the second array of recesses 174 are separated by a plurality of second fingers 176. The plurality of second fingers 176 are each formed so as to be tine-like having an upper surface 180 that slopes away from the plane of the platform portion 103, i.e. the plurality of second fingers 176 thicken vertically.

On the first side 154 of the platform portion 103, a first shallow wall 182 is integrally formed with the platform portion 103 adjacent the first array of recesses 164 and between the first array of recesses 164 and the socket portion 102. Similarly, on the second side 162 of the platform portion 103, a second shallow wall 184 is integrally formed with the platform portion 103 adjacent the second array of recesses 174 and between the second array of recesses 174 and the socket portion 102.

A first metallic leg 186 depends from the first side 154 of the platform portion 103 and a second metallic leg 188 depends from the second side 162 of the platform portion 103.

Referring to FIG. 1, the receiver optical sub-assembly 130 comprises, in this example, six connecting leads 190 for soldering to a receiver circuit board card 192 to provide connections to a photodiode (not shown) contained by the receiver optical sub-assembly 130.

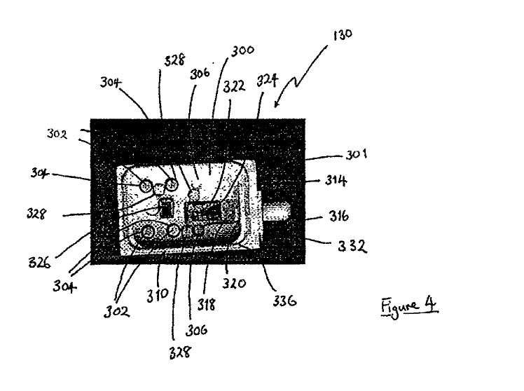

Referring to FIG. 4, the receiver optical sub-assembly 130 comprises a housing 301 that is substantially rectangular in cross-section, the housing 301 having a base 300 through which four active leads 302 of the six connecting leads 190 pass and protrude. The four active leads 302 are insulated from the base 300 by four respective insulating seals 304. Two remaining, inactive, leads 306 of the six connecting leads 190 are integrally formed with an outer surface 308 of the base 300 of the housing 301, the two inactive leads 304 and the four active leads 302 extend, in parallel, away from the outer surface 308 of the housing 301.

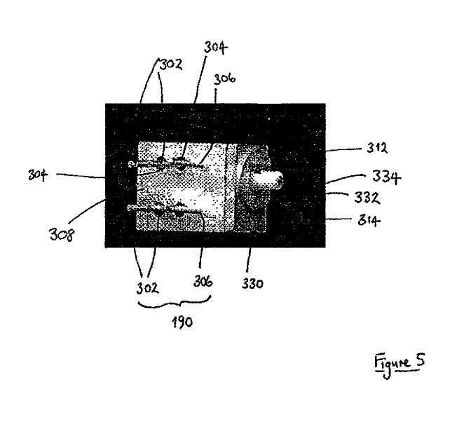

The housing 301 also comprises a peripheral wall 310 that surrounds the base 300 of the housing 301 and extends away from the base 300 to define a receptacle with the base 300, in this example the receptacle defining an open chamber. An aperture 312 is provided in a first side 314 of the peripheral wall 310, a ceramic ferrule 316 passing through the aperture 312 (FIG. 5) and being held in a fixed position by an adhesive, such as a suitable adhesive made by Ablebond. The ferrule 316 can be formed from a ceramic material, for example a glass ceramic material.

A recess, for example a pit 318, is formed in the base 300 adjacent the aperture 312, a side 320 of the pit 318 being in communication with the aperture 312. A support device, for example a micro-bench such as a silicon micro-bench 322 is bonded into the pit 318 and an optical fibre (not shown) passes through the centre of the ceramic ferrule 316 and runs along a groove (not shown) formed in the support device. The optical fibre is coupled to a photodiode 324 bonded upon the micro-bench 322. A globule of silicone lies over the photodiode 324. A globule of adhesive, such as Hysol EO 1062, can be deposited next to the silicone so as to retain the optical fibre in the groove.

In this example, the aperture 312 is not disposed centrally within the first side 314 of the peripheral wall 310, but when offset, conveniently facilitates compliance with at least one aspect of the small form factor dimensional requirements, for example when the receiver optical sub-assembly 130 is coupled to the receiver circuit board card 192. Since the pit 318 is in communication with the aperture 312, the pit 318 is not disposed centrally within the first side 314 of the peripheral wall 310. An integrated amplifier circuit 326 is bonded to the base 300 adjacent the pit 318 at a substantially central location between the protrusions of the four active leads 314 into the open chamber. Additionally, electrical components, for example capacitors 328, are epoxy bonded to the base 300 at sites on the base 300 convenient for wire bonding. Metal wire bonding (not shown) is provided between the integrated circuit 326, the electrical components 328 and the photodiode 324 as required for appropriate circuit interconnection between the integrated circuit 326, the electrical components 328 and the photodiode 324. Since this circuit interconnection depends upon an application-specific circuit design and the application specific circuit design is not the subject of embodiments of the invention, the metal wire bonding configuration will not be described further.

An outer surface 330 of the first side 314 of the peripheral wall 310 in which the aperture 312 is provided comprises an annular protrusion 332 surrounding the aperture 312, an electrically insulating washer (not shown) being disposed between an annular space 334 defined between the annular protrusion 332 and the ceramic ferrule 316. A metallic collar (not shown) is adhered to the first side 314 of the wall 300 in registry with the ceramic ferrule 316, the collar being electrically insulated from the housing 301 by the insulating washer. The collar, as part of the optical receiver sub-assembly 130, serves, inter alia, as an interface to facilitate coupling of the housing 301 to the second flexible coupling plate 136 by welding. A lid (not shown) is attached to an upper edge 336 of the peripheral wall 310 of the housing 301 to close the open chamber using a seam sealing technique, thereby preventing ingress of water into the closed chamber. Alternatively, the lid can be attached to the housing 301 by means of laser welding or an adhesive.

Although silicone has been described in this example, it should be appreciated that any barrier forming, substantially light transmissive, material can be used to prevent ingress of moisture to the photodiode 324 and/or the region where the photodiode 324 meets the optical fibre, for example, where a window of the photodiode 324 meets the optical fibre.

The receiver circuit board card 192 comprises six spaced apertures 194 through which the six connecting leads 190 pass, respectively. The six spaced apertures 194 through which the six connecting leads 190 pass are ultimately each filled with solder to hold the six connecting leads 190 in place with respect to the six spaced apertures 194, and hence to couple the receiver optical sub-assembly 130 to the receiver circuit board card 192.

The receiver circuit board card 192 is rectangular in shape having an upper longitudinal edge 196, a lower longitudinal edge 198, a front edge 200 and a rear edge 202. A first array of circuit board leads 204, or pins, are coupled to the lower longitudinal edge 198 of the receiver circuit board card 192. Tracks (not shown) on the receiver circuit board card 192 run between components and/or integrated circuits populating the receiver circuit board card 192 and the first array of circuit board leads 204 to permit electrical signals to travel on and off of the receiver circuit board card 192. In this example, the first array of circuit board leads 204 is attached to the receiver circuit board card 192 using a lead frame having an inter-lead pitch of 70 thousandths of an inch (1.778 mm). The first array of circuit board leads 204 is substantially co-planar with the receiver circuit board card 192 and depend from the lower edge 198 of the receiver circuit board card 192. Each lead of the first array of circuit board leads 204 passes through a respective recess of the first array of recesses 164 so that the first array of circuit board leads 204 is interdigitated with the plurality of first fingers 168.

A corner of the rear edge 202 and the lower longitudinal edge 198 sits in the first circuit board location slot 148 and a portion of the lower longitudinal edge 198 rests on, and is supported by, the first shallow wall 182. A vertical strip of an innermost surface 206 of the receiver circuit board card 192 opposite, and parallel with, the vertical partition 142 abuts an end of the transverse back plate 146 near the rear edge 202 of the receiver circuit board card 192.

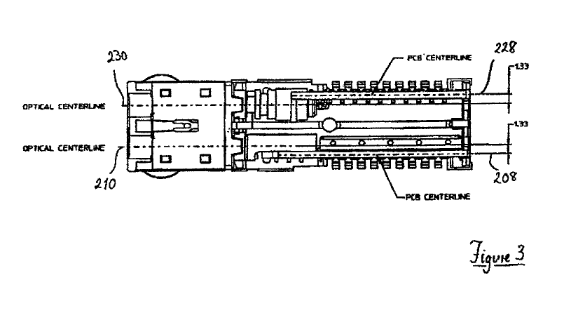

The first circuit board location slot 148 and the coupling of the receiver circuit board card 192 to the receiver optical sub-assembly 130 ensures that a first circuit board centreline 208 (FIG. 3), corresponding to a longitudinal linear disposition of the first array of circuit board leads 204, is spaced (shortest distance) a first predetermined distance, in this example 1.33 mm, from a first optical centreline 210 associated with the receiver optical sub-assembly 130.

Referring to FIG. 2, the transmitter optical sub-assembly 114 comprises, in this example, three connecting leads 212 for soldering to a transmitter circuit board card 214. The transmitter circuit board card 214 comprises three spaced apertures 216 through which the three connecting leads 212 pass, respectively. The three spaced apertures 216 through which the three connecting leads 212 pass are ultimately each filled with solder to hold the three connecting leads 212 in place with respect to the three spaced apertures 216, and hence to couple the transmitter optical sub-assembly 114 to the transmitter circuit board card 214.

The transmitter circuit board card 214 is rectangular in shape having an upper longitudinal edge 218, a lower longitudinal edge (not shown), a front edge 220 and a rear edge 222. A second array of circuit board leads 224 are coupled to the lower longitudinal edge of the transmitter circuit board card 214. Tracks (not shown) on the transmitter circuit board card 214 run between components and/or integrated circuits populating the transmitter circuit board card 214 and the second array of circuit board leads 224 to permit electrical signals to travel on and off of the transmitter circuit board card 214. In this example, the second array of circuit board leads 224 is attached to the transmitter circuit board card 214 using a lead frame having an inter-lead pitch of 70 thousandths of an inch (1.778 mm). The second array of circuit board leads 224 is substantially coplanar with the transmitter circuit board card 214 and depend from the lower edge of the transmitter circuit board card 214. Each lead of the second array of circuit board leads 224 passes through a respective recess of the second array of recesses 174 so that the second array of circuit board leads 224 is interdigitated with the plurality of second fingers 176.

A corner of the rear edge 222 and the lower longitudinal edge of the transmitter circuit board card 214 sits in the second circuit board location slot 156 and a portion of the lower longitudinal edge of the transmitter circuit board card 214 rests on, and is supported by, the second shallow wall 184. A vertical strip of innermost surface 226 of the transmitter circuit board card 214 opposite, and parallel with, the vertical partition 142 abuts an end of the transverse back plate 146 near the rear edge 222 of the transmitter circuit board card 214.

The second circuit board location slot 156 and the coupling of the transmitter circuit board card 214 to the transmitter optical sub-assembly 114 ensures that a second circuit board centreline 228 (FIG. 3), corresponding to a longitudinal linear disposition of the second array of circuit board leads 224, is spaced (shortest distance) a second predetermined distance, in this example 1.33 mm, from a second optical centreline 230 associated with the transmitter optical sub-assembly 114.

During normal assembly, the circumferential shoulder 116 of the transmitter optical sub-assembly 114 and the circumferential shoulder 132 of the receiver optical sub-assembly 130 are welded to the first flexible coupling plate 118 and the second flexible coupling plate 136 respectively. The transmitter optical sub-assembly 114 is inserted into the first circular aperture 112 and the first central portion 119, the second tab and the third tab of the first flexible coupling plate 118 are wrapped around the socket portion 102. Similarly, the receiver optical sub-assembly 130 is inserted into the second circular aperture 128 and the second central portion 138, the second tab and the third tab of the second flexible coupling plate 136 are wrapped around the socket portion 102.

The receiver and transmitter circuit board cards 192, 214 are assembled in accordance with any circuit board manufacturing technique known in the art, the components and/or integrated circuits and track topologies for the receiver and transmitter circuit board cards 192, 214 being such that the receiver and transmitter circuit board cards 192, 214 perform functions of their respective designs. Board leads, or pins, are attached to pads formed at the lower edge 198 of the receiver circuit board card 192 and the lower edge of transmitter circuit board card 214. The board leads are attached to the pads using lead frames and the leads, once push fitted, are soldered to the pads. The receiver circuit board card 192 is then inserted sideways onto the platform portion 103 towards the vertical partition 142 so that the board leads attached to the receiver circuit board card 192 are individually received by respective recesses of the first array of recesses 164. The receiver circuit board card 192 is inserted and manipulated until the corner of the rear edge 202 and the lower longitudinal edge 198 sits in the first circuit board location slot 148 and the six connecting leads 190 pass through the six spaced apertures 194, respectively, and the innermost surface 206 of the receiver circuit board card 192 abuts the receiver optical sub-assembly 130 and the transverse back plate 146. The six connecting leads 190 are then respectively soldered in the six spaced apertures 194.

With respect to the transmitter optical sub-assembly 114, the three connecting leads 212 are bent by a lead forming tool prior to coupling of the transmitter optical sub-assembly 114 to the socket portion 102 so that the three connecting leads 212 pass through the three spaced apertures 216 when the transmitter circuit board card 214 is in place in the platform portion 103. In this respect, the transmitter circuit board card 214 is inserted sideways onto the platform portion 103 towards the vertical partition 142 so that the board leads attached to the transmitter circuit board card 214 are individually received by respective recesses of the second array of recesses 174. The transmitter circuit board card 214 is inserted and manipulated until the corner of the rear edge 222 and the lower longitudinal edge of the transmitter circuit board card 214 sits in the second circuit board location slot 156 and the three connecting leads 212 pass through the three spaced apertures 216, respectively, and the innermost surface 226 of the transmitter circuit board card 214 abuts the end of the transverse back plate 146. The three connecting leads 212 are then each soldered in their respective aperture of the three spaced apertures 216. 3011151

Finally, the ground cap 108 is attached to the socket portion 102 and the outer protective housing (not shown) is attached to the platform portion 103 in order to protect the apparatus on the platform portion 103 and provide shielding from Electromagnetic Interference (EMI).

The optical transceiver module can then be soldered to a printed circuit board of an optical communications system by the leads of the transmitter and receiver circuit board cards 192, 214.

What is claimed is:

1. A package apparatus for an optoelectronic device, the package comprising:
a receptacle containing a support device supporting an optoelectronic device;
a plurality of leads communicating between an interior of the receptacle and an exterior of the receptacle, wherein
the support device and the optoelectronic device are substantially covered in a sealant material.

2. An apparatus as claimed in claim 1, wherein the receptacle comprises a recess, the support device being disposed within the recess.

3. An apparatus as claimed in claim 1, wherein the receptacle comprises a side wall having an opening for permitting passage of an optical fibre into the receptacle.

4. An apparatus as claimed in claim 3, further comprising a ferrule disposed, in part, in the aperture.

5. An apparatus as claimed in claim 3, wherein the side wall has an outer surface relative to the open chamber, the aperture being disposed non-centrally in the outer surface.

6. An apparatus as claimed in claim 4, wherein the outer ferrule is a ceramic ferrule.

7. An apparatus as claimed in claim 3, wherein the side wall comprises an outer surface and a shoulder formed with the outer surface, the shoulder surrounding the aperture.

8. An apparatus as claimed in claim 7, wherein the shoulder is defined by a protrusion that extends away from the outer surface of the side wall.

9. An apparatus as claimed in claim 7, wherein a ferrule is disposed, in part, within the aperture, an annular volume being defined between the shoulder and the ferrule.

10. An apparatus as claimed in claim 7, wherein an electrically insulating element is disposed adjacent the shoulder.

11. An apparatus as claimed in claim 9, wherein an electrically insulating washer is disposed in the annular volume.

12. An apparatus as claimed in claim 1, wherein the cross sectional area of the receptacle is substantially rectangular.
